(19) United States
(12) Patent Application Publication
(10) Pub. No.: US 2001/0051481 A1
(43) Pub. Date: Dec. 13, 2001

(54) COMPOSITE CHEMICAL BARRIER FABRIC WITH ENHANCED DURABILITY

(76) Inventor: TODD ROBERT CARROLL, GUNTERSVILLE, AL (US)

Correspondence Address: WADDEY & PATTERSON, 414 UNION STREET, SUITE 2020, BANK OF AMERICA PLAZA, NASHVILLE, TN, 37219

(21) Appl. No.: 09/128,721

(22) Filed: Aug. 4, 1998

(51) Int. Cl. B32B 3/00; B32B 27/04

(52) U.S. Cl. 442/71; 442/290; 442/396; 442/398; 428/332

(57) ABSTRACT

A flexible, heat sealable, composite chemical barrier fabric which exhibits enhanced durability characteristics comprised of a multi-layered chemical barrier material or fabric that has been coated on one or more sides with a layer of halogen-free thermoplastic olefin resin (TPO). Fabrics having this structure show enhanced durability characteristics while maintaining a high degree of chemical resistance and heat sealability. More specifically, embodiments are included that show order of magnitude increases in various measures of durability including flex crack resistance, abrasions resistance, and resistance to puncture as compared to un-coated fabrics.

### FIELD OF INVENTION

This invention relates generally to materials and fabrics used in the manufacture of protective garments, seam tape, interface, zippers, gloves, covers, shelters, tentage, flexible containment systems and the like where flexibility, chemical resistance, and defined durability are required. These materials and fabrics are used primarily in the manufacture of chemical protective garments and gloves used to isolate wearers from exposure to hazardous environmental conditions. Critical to achieving this objective is ensuring that the fabrics are easily converted into complex designs such as fully encapsulating gas-tight suits. Hot air welding has been found to be one of the most economical and effective sealing techniques used on chemical protective garments and the embodiments disclosed therein maintain their heat sealability.

### BACKGROUND OF THE INVENTION

Multi-layered, high chemical barrier materials and fabrics have achieved wide spread acceptance throughout the hazardous materials handling community. There are numerous commercial examples of these materials and fabrics that have either been used, or are currently still in use throughout the United States and Internationally (i.e., Responder® (Kapper Safety Group), Barricade® (DuPont), CPF® 1,2,3,4 (Kappler), Tychem® 7500, 9400, 10,000 (DuPont), TLU® (Trelleborg), Silver Shields® (North), 4H® (Safety 4), etc.) Multi-layered high chemical barriers have received such acceptance since they offer a combination of high chemical permeation resistance, low weight, low base fabric cost, and low manufacturing costs. The greatest disadvantage of limited-use fabrics has been their relatively low performance with respect to physical durability (i.e., tensile strength, flex, puncture, abrasion, etc.) which limits their usable service life.

Limited-use fabrics replaced the traditional expensive, heavyweight, durable, vulcanized/crosslinked materials of the past (i.e., Viton®, Neoprene, Butyl, Natural Rubber, etc). These durable fabrics typically exhibit good physical properties (i.e., flex crack, cut, tear, and abrasion) and can be easily compounded to exhibit flame resistant and anti-static properties. While their greatest advantage is durability, their greatest disadvantage is their limited chemical resistance. In addition, durable fabrics have traditionally required higher manufacturing costs, and tend to be more vulnerable to environmental stresses (i.e., ozone, UV, etc.) than their limited-used counter parts.

The development of multi-layered high chemical barrier fabrics created what is now known as the limited-use protective clothing market. As the name suggests, limited-use materials offer defined performance characteristics over a specified duration. Currently, limited-use garments are being used for a relatively short time period, (i.e., whole or partial work shift) and than discarded since the materials of construction exhibit only limited durability characteristics. In comparison to durable fabrics, limited-use fabrics typically exhibit low puncture, abrasion, and flex crack resistance which limits their useable service-life. It has also proved difficult to add other performance characteristics to limited-use materials such as anti-static properties and flame resistance without drastically affecting chemical resistance and heat sealability.

Durable materials are not only more expensive than limited-use fabrics from a base fabric cost, but manufacturing costs are also high as a result of the labor intensive cementing procedure required to manufacture liquid- and gas-tight seams. The multi-layered chemical barriers lend themselves to a much lower cost manufacturing technology termed hot air welding. Rather than using adhesives in the cementing process which are sensitive to environmental stresses, hot air welding relies on the thermoplastic characteristic of the outer most layer of the fabric and the inner-most layer of the seam tape/strapping. In hot air welding, the seam tape and fabric actually create an intimate, inseparable bond which is not affected by environmental stresses.

Limited attempts have been made in the past to combine the durable characteristics of reusable fabrics with the high chemical resistance of multi-layered chemical barriers. Until now, all previous attempts have combined rubberized outer-layers with various multi-layered chemical barrier inner-layers. Since rubberized materials are traditionally not hot air weldable, this approach limits production of the composite materials to the glued seam process. This seaming technique is labor and time intensive, additionally, the adhesives used are sensitive to environmental hazards such as UV, ozone, and humidity extremes.

### SUMMARY OF THE INVENTION

The present invention presents a composition obtained by combining high chemical resistant and heat sealability of limited-use fabrics wherein the durability and adaptability characteristics are achieved thus allowing the fabric and suits made therefrom to be reusable. A flexible, heat sealable, composite chemical barrier fabric composition has been produced which allows for enhanced durability characteristics. The composition is, for example, comprised of a multiple layer chemical barrier material or fabric that has been coated on at least one side with a layer of a halogen free thermoplastic olefin (TPO) resin. These (TPO) resins have by design a narrow molecular weight distribution. The target molecular weight of the resin has generally determined the ultimate processability and performance of the resin. Thinner coatings (i.e. more flexible finished fabrics) can be achieved through low molecular weight grades of the resins with molecular weight determining the overall physical properties of the resulting coated product. In general, low molecular weight resins will result in a thin coated composite which exhibits only marginal improvement in physical durability, while a high molecular weight resin coating will result in a thicker coated composite which offers excellent strength and abrasion resistance but at the expense of an excessively stiff fabric. TPO resins with molecular weight distributions in the range of 0.85-0.95 offer a desired compromise between processability, physical durability and flexibility; especially resins comprised substantially of polypropylene, polypropylene-polyolefin copolymers and blends of polypropylene-polyolefins, olefins defined as a class of unsaturated aliphatic hydrocarbons of the general formula CnCH₂n and named after the corresponding paraffins by adding “ene” or “ylene” to the sterr, for example, ethylene, propylene, butenes and the like.

Composite chemical barrier fabrics with enhanced durability in accordance with the present invention show orders of magnitude increases in various measurements of durability including flex crack resistance, abrasion resistance and resistance to puncture as compared to uncoated fabrics. The thrust of the present invented composition overcomes the greatest disadvantage of limited-use fabrics through enhanced performance (i.e. physical durability) thus allowing for an economical barrier fabric exhibiting durable characteristics of reusable fabrics as well as the high chemical resistance of multi-layered chemical barriers.

### BRIEF DESCRIPTION OF THE DRAWINGS

FIG. 1 is an enlarged cross-sectional view of the composite chemical barrier fabric exhibiting enhanced durability characteristics having a halogen free thermoplastic olefin resin coating 14.

FIG. 2 is an enlarged cross-sectional view having coatings (24 and 26) on both sides of the receptive substrate 22;

FIG. 3 is an enlarged cross-sectional view of a Responder® substrate having a ten mil protection resin coating 34 on one surface;

FIG. 4 is an enlarged cross-sectional view of a receptive substrate LLDPE surface coated with a 5 mil resin coating 44;

FIG. 5 is an enlarged cross-sectional view of a receptive substrate having 5 mil resin coatings 54 and 56 on side one and side two of the receptive substrate; and

FIG. 6 is an enlarged cross-sectional view of a resin protective coating on a dealing tape substrate.

There exist a strong need in many market sectors, for example, in the field of food containers and in the medical and packaging fields, for polyolefin compositions based on polypropylene which have high impact resistance even at low temperature. Moreover, in the field of food containers, it is desirable that the polyolefin compositions have high rigidity values. In the medical and packaging fields it is also necessary that the polyolefin compositions have a sufficient flexibility. In the present field of composite chemical barrier fabrics with enhanced durability, a coating film comprised of a selection of polyolefins i.e. thermal plastic olefins is necessary in order to achieve high impact resistance and flexibility with an additional feature that the thermal plastic olefin coating materials exhibit an inherent thermal plastic affinity to the chemical barrier substrate (i.e., receptive substrate) allowing bonding to occur between the substrate and the thermal plastic olefin coating. The thermal plastic olefin coatings according to the invention are generally halogen free allowing for ease of disposal under EPA rules and regulations. The thermal plastic olefins in accordance with the present invention can be selected from mono or co-polymers, for example, polyethylene/ethylene, polyethylene/1-butane and polypropylene copolymers with other olefin polymers. Blends of polymers and co-polymers of the olefin families can be suitable for use of the present invention if the extrusion coating characteristics of the resins are desirable and that the extruded resins can be utilized with one or more layers within a free standing multi-layered co-extrusion film. The composite chemical barrier fabric with enhanced durability in accordance with the present invention brings together the outer surface of a chemical barrier substrate which exhibits an inherent thermal plastic finity therefore allowing bonding to occur between the substrate and the TPO coating.

Olefin polymer materials, in particular, propylene polymer materials, have been widely used in various applications, such as fibers, films, sheets and other shaped articles because of their excellent physical, chemical, and mechanical properties. However, the thermal plastic olefin materials in accordance with the present invention must exhibit certain characteristics which promote the durability of the composite chemical barrier fabric substrate and in addition of potentially utilizing copolymers and polymer blends of the thermal plastic olefins, thermal plastic elastomers of crystalline anomorphous content copolymers can be utilized as long as the end result sheet material when laminated onto the composite chemical barrier substrate provide a desired enhanced durability.

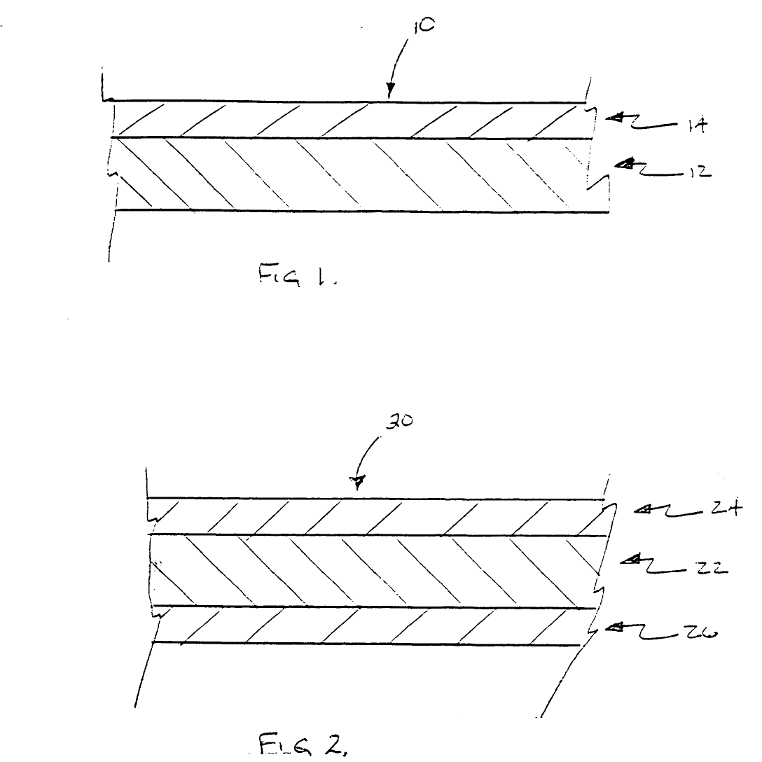

Referring to FIG. 1, a composite chemical barrier fabric exhibiting enhanced durability characteristics 10 is shown. The composite includes a receptive substrate 12, and a 5 mil coating of a halogen-free thermoplastic olefin resin. The receptive substrate 12, in this embodiment is a commercially available limited-use fabric marketed under the tradename Responder® (Kappler Safety Group).

Such a commercially available limited-use-of fabric as Responder® can be comprised of a multi-layered fabric having a base sheet of fabric having internal open spaces, a first multilayered film sheet laminated to one face thereof and a second multi-layered film sheet laminated to its opposite face; the first multi-layered film sheet comprising a film of ethylene vinyl alcohol, a film layer of nylon laminated to each face thereof and an outer film of heat sealable polyethylene; and the second multilayered film sheet comprising a film of polyvinylidine chloride having a film of ethylene vinyl acetate laminated to the inner face thereof and a film of heat sealable polyethylene laminated to its outer face. Samples of a fabric having the structure described when subjected to independent laboratory testing by exposure to 15 liquid chemicals listed below using the ASTM's F739 method, provide a chemical barrier within limits which satisfy industry standards. The 15 liquid chemicals constituting those liquids included in the ASTM F1001 chemical test battery include compounds as follows:

acetone, ketone;

acetonitrile, nitrile;

carbon disulfide, organic sulfur;

dichloromethane, chlorinated paraffin;

diethylamine, amine;

dimethyl-formamide, amide;

ethyl acetate, ester;

n-hexane, saturated hydrocarbon

methanol, primary alcohol;

nitrobenzene, nitro compound;

sodium hydroxide 50%, inorganic base;

sulfuric acid 93%, inorganic mineral acid;

tetrachloroethylene, chlorinated olefin;

tetrahydrofuran, heterocyclic & ether; and

toluene, aromatic hydrocarbon.

The linear-low density polyethylene surface of layer 12 is extrusion coated with a 5 mil layer of a clear TPO resin, 14, which is available from Montell Polyolefins (Adflex® KS-353P). One example of the TPO which is suitable in accordance with the present invention has the following ASTM method physical properties.

| | ASTM | Adflex |
|---|---|---|
| | Method | KS-353P |
| Melt Flow Rate, 230/2.16, g/10 min | D 1238 | 0.45 |
| Density at 23° C., g/cm³ | D 792 | 0.88 |
| Tensile Strength at Yield, psi (MPa) | D 638 | 900 (6) |
| Tensile Elongation at Yield, % | D 638 | 25 |
| Flexural Modulus, 1% Secant at 0.05 in/min | D 790A | 12,000 (86) |
| psi (MPa) | | |
| Hardness, Shore D, Instant | D 2240 | 40 |
| Notched Izod Impact Strength at 23° C., | D 256A | No Break |
| ft-lbs/in (J/m) | | |
| Environmental Stress-Cracking Resistance, hrs | D 1693 | >3000 |

The property values shown are measured, where applicable, on injection molded test specimens. Adflex KS-353P thermoplastic olefin resin is excellent for calendered and extruded sheet, as well as monolayer and multilayer air quenched blown films. It can be used on conventional PVC calendering equipment, sheet extruders and LLDPE and HDPE film extrusion equipment.

This resin is ideal for making soft hygienic or heavy duty films. It can also be used to modify LDPE or LLDPE resins in order to improve mechanical characteristics, puncture resistance. The TPO is suitable for applications in accordance with the present invention provide outstanding heat sealability and outstanding puncture resistance. The TPO's are plasticizer fee and have excellent low temperature impact resistance as well as excellent chemical and environmental stress-cracking resistance.

### EXAMPLE 1

The resin was processed using a single, barrier-type screw (L/D ratio 24/1) which was fitted with a Maddock® mixing section. A traditional multiple-screen pack profile was used inline between the extruder outlet and the five zone heated horizontal die. Die zone temperatures were maintained at 395 degrees Fahrenheit while extruder barrel zone temperatures were set at 480-490 degrees Fahrenheit. Head pressure was maintained between 3700 and 3900 psi while the melt temperature into the die was measured at 470 degrees Fahrenheit. The TPO resin was extruded onto the substrate and then immediately cooled by running the composite over a chill roller.

Samples of fabric having the structure described above were subjected to puncture resistance testing in accordance with ASTM 1342 as summarized in Table 3. Puncture resistance of the composite chemical barrier was increased by 92.5% with the addition of a 5 mil TPO coating as described under this embodiment. Other embodiments described below, showed increases in puncture resistance of 111% (Embod. #2), 110% (Embod.#4), and 133% (Embod.#5).

### EXAMPLE 2

Table 4 summarizes results obtained when evaluating flex crack resistance in accordance with ISO 7854 Method B (modified) for several example embodiments. This method exposes a small tube of fabric to a high speed unidirectional flex motion. Post flex condition was evaluated by placing the flexed sample in a holder that could be placed under either pressure or vacuum. Cracking was determined by covering the sample with water, pressurizing the chamber to 16-in water gage pressure, and visually observing for bubbles. Embodiment #1 demonstrated more then an 800% increase in flex crack resistance while Embodiment #4 demonstrated more than a 650% increase in flex crack resistance.

### EXAMPLE 3

An alternative embodiment, 20, as shown in FIG. 2 includes 5 mil TPO coatings, 24 and 26, on both exterior surfaces of the receptive substrate 22. The receptive substrate 22, in this embodiment is the same Responder® (Kappler Safety Group) fabric used under embodiment #1.

### EXAMPLE 4

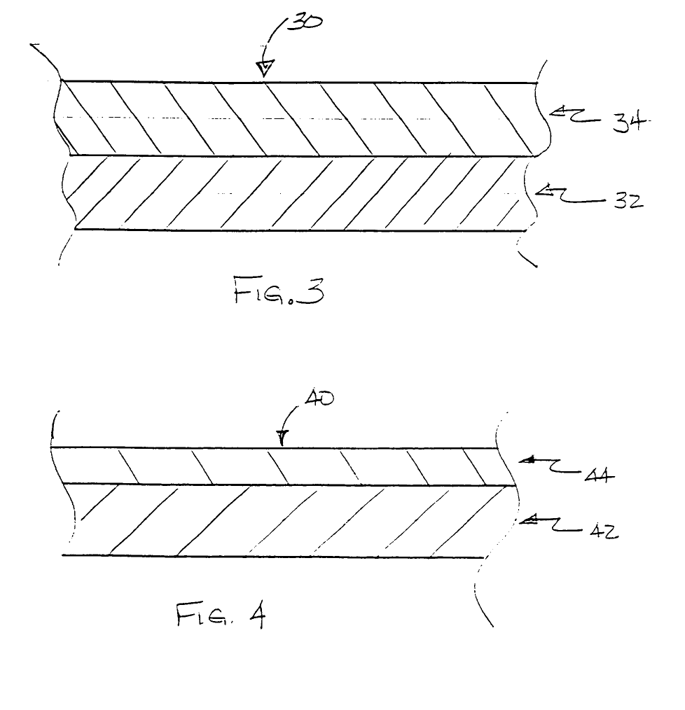

An alternative embodiment, 30, as shown in FIG. 3 includes a 10 mil TPO coating, 34 onto the LLDPE surface of same Responder® substrate, 32, used under Embodiment #1. This embodiment demonstrates the ease with which thickness of the TPO coating can be controlled. In this case however, the added TPO made the final fabric objectionably stiff. Flexibility, as it relates to thickness with TPO resins, is in part determined by the molecular weight and molecular weight distribution of the selected resin. By design, TPO resins have narrow molecular weight distributions. The target molecular weight of the resin will in large part determine the ultimate processability and performance of the resin.

Thinner coatings (i.e., more flexible finished fabrics) can be achieved through lower molecular weight grade TPOs. Molecular weight, however, determines the overall physical properties of the resulting coated product. Using low molecular weight TPO's will result in a thin coated composite which exhibits only marginal improvements in physical durability, while high molecular weight TPO resins will result in thicker coated composites which offer excellent strength and abrasion resistance but at the expense of an excessively stiff fabric. TPO resins with molecular weight distributions in the range of 0.85-0.95 appear to offer the optimum compromise between processability, physical durability, and flexibility.

### EXAMPLE 5

An alternative embodiment, 40, as shown in FIG. 4 includes a 5 mil TPO coating, 44, onto the LLDPE surface of an alternative receptive substrate 42 (Responder Plus®, Kappler Safety Group). This embodiment demonstrates the impact of the substrate on the ultimate hand and drape of the final composite. As shown in Table 3, and 4, this embodiment (#4) exhibits significant improvements in both puncture resistance as well as resistance to flex crack resistance, but also resulted in a fabric that was more comfortable to wear when configured into a finished garment than embodiment #1.

### EXAMPLE 6

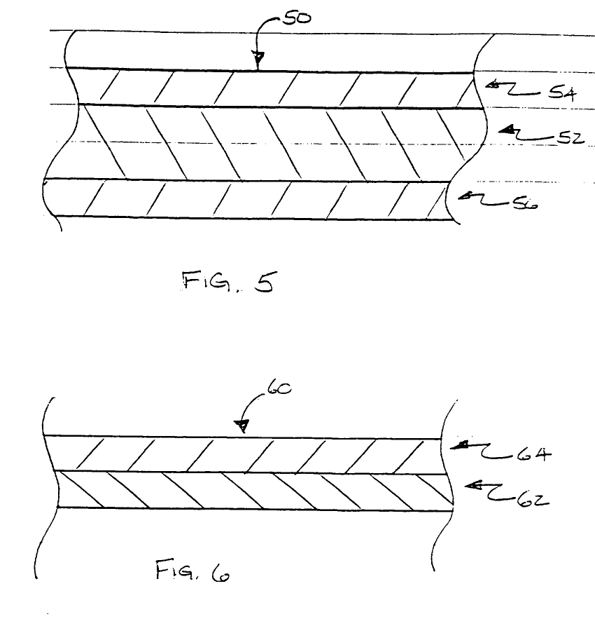

An alternative embodiment, 50, as shown in FIG. 5 includes 5 mil TPO coatings, 54 and 56, on both exposed surfaces of the receptive substrate 52.

### EXAMPLE 7

An alternative embodiment, 60, as shown in FIG. 6 includes a 5 mil TPO coating, 64, onto the LLDPE surface of an alternative receptive substrate 62. In this case, the substrate, 62, is a sealing tape which is available through Kappler Safety Group which is used to create vapor- tight seals over sewn seams in a final configured garment. The TPO surface, 64, is heated to its melting point and laminated down under pressure to the top surface, 14, of the base fabric, 10, using conventional hot air welding equipment such as available through Queenlight, Pffath, etc. Another novel use of this embodiment is as an interfacing layer to join the PVC visor and zipper to the garment. The majority of visors and gas-tight zippers used in the manufacture of encapsulating chemical protective garments are constructed on polyvinyl chloride. TPO does not have an inherent thermoplastic affinity for PVC, therefore, it was necessary to develop an interfacing material to facilitate the ultimate usefulness of the subject invention. In this situation, a three tiered approach was necessary to enable easy fabrication of gas-tight encapsulating garments. The PVC visor and zipper were interfaced with a strip of commercially available polyvinyl chloride/chlorinated polyethylene alloy, and further interfaced with a strip of commercially available 100% CPE material. The TPO coated seam tape was then further laminated (TPO-side up), to the visor and zipper, and then set/sewn into the garment. A gas-tight union is then made between the interfaced visor and zipper, and the garment by heat sealing an additional layer of TPO-coated seam tape (TPO-side down) over the sew line.

Variations on this embodiment can also be used with alternative multi-layered films in the fabrication of two and three dimensional chemically resistant gloves. In this form, the rubber-like characteristics and high coefficient of friction of the TPO coating aids in the tactile properties of a glove over non-coated multi-layered film composites glove available through North Hand Protection (Silver Shield®) and Safety 4 (4H®). While these commercially available glove offer superior chemical resistance, fine motor skills, and tactile performance is drastically inhibited by the low coefficient of friction of the outer most surface of the gloves. A thin layer of TPO resin on the outer most surface has been shown to drastically improve the overall performance of film based gloves.

Table 1 shows the greatest advantage of limited-use chemical protective fabrics. This table summarizes breakthrough times (minutes) as measured using the industry standard for chemical resistance (ASTM F739). Data is presented on 15 chemicals selected from the ASTM F1001 standard list of chemicals. Breakthrough time is essentially the time it takes for a chemical to move through a fabric after exposure, and become measurable on the other surface. It is very clear from this table data that limited-use materials offer enhanced chemical resistance when compared to durable fabrics. The limited durability characteristics exhibited by limited-use fabrics represents their greatest disadvantage.

TABLE 1
Chemical Resistance of Protective Fabrics
(Breakthrough Time per ASTM F739, minutes)

| | Durable | Durable | Limited-Used | Limited-Use |
|---|---|---|---|---|
| | Fabric #1 | Fabric #2 | Fabric #1 | Fabric #2 |
| Chemical | (Butyl) | (PVC) | (Responder) | (CPF 3) |
| acetone | 125 | 8 | >480 | >480 |
| acetonitrile | 120 | 8 | >480 | 7 |
| carbon disulfide | 2 | 2 | >480 | 16 |
| dichloromethane | 4 | 4 | >480 | 7 |
| diethylamine | 3 | 15 | >480 | >480 |
| dimethylforma- | >480 | 24 | >480 | >480 |
| mide | | | | |
| ethyl acetate | 28 | 8 | >480 | >480 |
| n-hexane | 4 | 8 | >480 | >480 |
| methanol | 304 | 13 | >480 | 8 |
| nitrobenzene | >480 | >480 | >480 | >480 |
| sodium hydroxide | >480 | >480 | >480 | >480 |
| sulfuric acid | 439 | 150 | >480 | >480 |
| tertachloroethy- | 1 | 13 | >480 | >480 |
| lene | | | | |
| tetrahydrofuran | 9 | 7 | >480 | >480 |
| toluene | 6 | 8 | >480 | >480 |

This invention addresses these issues by combining high chemical resistance and heat sealability of limited-use fabrics with the durability and adaptability (i.e., modifiable to allow for anti-static and flame resistance additives) characteristics of reusable materials. Table 2 includes several embodiments that have been made to support the potential breath and flexibility of this invention. Tables 3, 4, and 5 include data to support the claim that novel coatings and laminations can be used to enhance the durability characteristics of limited-use fabrics.

The degree to which the durability of limited-use materials can be enhanced can be controlled by adjusting coating thickness and orientation (front and/or back side coating). It should be obvious that thick coatings will increase cut, tear, puncture, and abrasion but at the expense of flexibility.

The preferred halogen-free TPO containing fabric is prepared by extrusion coating the resin directly onto one or more surfaces of a receptive substrate as detailed below. It is also conceivable to utilize the resin as one or more layers within a free standing multi-layered coextruded film that could then be combined with other materials and configured into a final item such as tentage, portable containment systems, gloves, and the like. The halogen-free nature of the durable enhancing coating does not inhibit or affect the disposal option of the base substrate fabric.

The outermost surface of a candidate substrate must be receptive to the TPO coating by exhibiting an inherent thermoplastic affinity to allow bonding to occur between the substrate and the TPO coating. Adequate bond strength is critical to ensure acceptable performance in the final configured protective item. Bond strength will vary depending on the density, melt index, and thickness of the TPO as well as the exposed polymeric surface of the receptive substrate.

TABLE 2
PREFERED EMBODIMENTS

| | | Coating | |
|---|---|---|---|
| Embodiment | Base Fabric | Configurations | Coating Thickness |
| #1 | Responder | front side | 5 mils |
| #2 | Responder | front side/back side | 5 mils/5 mils |
| #3 | Responder | front side | 10 mils |
| #4 | Responder Plus | front side | 5 mils |
| #5 | Responder Plus | front side/back side | 5 mils/5 mils |
| #6 | Seam Tape | front side | 5 mils |

TABLE 3
ASTM F1342 Puncture Resistance

| Substrate | Un-coated | Coated 1-Side | Coated 2-Side |
|---|---|---|---|
| Responder | 2.7 lb_{f} | 5.2 lb_{f} | 5.7 lb_{f} |
| | | (Embod. #1) | (Embod. #2) |
| Responder Plus | 3.0 lb_{f} | 6.3 lb_{f} | 7.0 lb_{f} |
| | | (Embod. #4) | (Embod. #5) |

TABLE 4
Iso 7854 Method B - Flex Resistance

Flex Cycles to Failure

| Fabric | un-coated | coated |
|---|---|---|
| Responder | <5,000 | >40,000 |
| | | (Embod. #1) |
| Responder Plus | 50-70,000 | >480,000 |
| | | (Embod. #4) |

Table 2 shows the embodiments of the figures.

Table 5 includes several additional embodiments that have been made to support the potential breath and flexibility of this invention.

The degree to which the durability of limited-use materials can be enhanced can be controlled by adjusting the coating thickness and orientation (front and/or back side coating). It should be obvious that thicker coatings will increase cut, tear, puncture, and abrasion but at the expense of flexibility.

TABLE 5
PREFERRED EMBODIMENTS

| Embodiment | Base Fabric | Coating Configurations | Coating Weight |
|---|---|---|---|
| #7 | Seam Tape | front side/back side | 5 mils/5 mils |
| #8 | CP225 | front side | 5 mils |
| #9 | CP225 | front side/back side | 5 mils/5 mils |

It may be seen from the above that the applicant has provided a novel and major improvement in the durability characteristics of multi-layered high chemical barrier film composite fabrics. In addition, the fabrics may be readily and economically fabricated into garments using conventional heat-sealed seams.

1. A composite chemical barrier fabric having improved durability comprising:
a chemical barrier, multiple layer compositions coated on at least one side with a film of thermoplastic polyolefin with a molecular weight distribution range of from about 0.85 to about 0.95, the coated chemical barrier composite achieving at least about 25% improvement in puncture resistance and at least about 25 % improvement in flex-crack resistance of the fabric.

2. The composite chemical barrier fabric of claim 1 wherein the chemical barrier, multiple layer compositions contains at least one stratum selected from the group consisting of polyvinylidene chloride, ethylene vinyl acetate, ethylene vinyl alcohol, nylon, polyvinyl alcohol. polyester, polytetraflouroethylene, fluorinated ethylene propylene, polyvinyldene chloride copolymer, acrylic, acrylonitrile copolymer, ionomers, Surlyn, polybutylene, metalized polyester, polypropylene, oriented polypropylene, polyamide, and the like.

3. The composite chemical barrier fabric according to claim 2 wherein the multi-layer compositions have one or more exposed surfaces selected from the group consisting essentially of polyethylene, ethylene ethyl acrylate, ethylene methyl acrylate, ethylene vinyl acetate, ethylene vinyl acetate copolymer, or polypropylene.

4. The composite chemical barrier fabric of claim 3 wherein the thermoplastic polyolefin coating has a thickness greater than 1 mil.

5. The composite chemical barrier fabric of claim 4 wherein the thermoplastic polyolefin coating has a more specific thickness of at least about 1 mils to about 10 mils.

6. The composite chemical barrier fabric of claim 3 wherein the thermoplastic polyolefin is in the form of a free film and is laminated to one or more of the exposed surfaces of the chemical barrier, multiple film composition.

7. The composite chemical barrier fabric of claim 1 wherein the fabric is configured into items of protective clothing including suits, gloves, hoods and shoe covers.

8. The composite chemical barrier fabric of claim 1 wherein the seams are sealed using hot air welding.

9. The composite chemical barrier fabric of claim 1 wherein the fabric is slit to a narrow width for use as a seam sealing tape.

10. The composite chemical barrier fabric of claim 1 wherein the fabric is slit to a narrow width and used as an interfacing material in combination with PVC and PVC/CPE alloy fabrics to create gas-tight unions between PVC visors and PVC zippers.

11. The composite chemical barrier fabric of claim 1 wherein the fabric is a coextruded multi-layered chemical barrier with one or more exterior layers of thermoplastic polyolefin.

12. The composite chemical barrier fabric of claim 1 wherein the thermoplastic polyolefin film is comprised of polypropylene.

13. A composite chemical barrier fabric having improved durability, comprising:
a chemical barrier, multiple film composition created on at least one side with a layer of a thermoplastic olefin resin, the resin having an ASTM D1238 melt flow rate 230/2.16 g/10min of about 0.45; an ASTM D793 density at 23 degrees celsius. g/cm³ of about 0.88; and an ASTM D1693 environmental stress-cracking resistance, hours of about >3,000.

14. The composite chemical barrier fabric according to claim 13 wherein the resin is comprised substantially of polypropylene.

15. The composite chemical barrier fabric according to claim 13 wherein the resin is comprised of polypropylene, polyethylene copolymers.

16. The composite chemical barrier fabric according to claim 13 wherein the resin is comprised of blends of polypropylene and polyethylene.

17. The composite chemical barrier fabric according to claim 13 wherein the resin is comprised of a majority of polypropylene mixed with other thermoplastic olefin resins.

18. The composite chemical barrier fabric of claim 13 wherein the chemical barrier, multiple film composition containing at least one stratum selected from the group consisting essentially of polyvinylidene chloride, ethylene vinyl acetate, ethylene vinyl alcohol, nylon, polyvinyl alcohol, polyester, polytetraflouroethylene, fluorinated ethylene propylene, polyvinyldene chloride copolymer, acrylic, acrylonitrile copolymer, ionomers, Surlyn. polybutylene, metalized polyester, polypropylene, oriented polypropylene, polyamide, and the like.

19. The composite chemical barrier fabric according to claim 18 wherein the multi-layer film has one or more exposed surfaces selected from the group consisting essentially of polyethylene, ethylene ethyl acrylate, ethylene methyl acrylate, ethylene vinyl acetate, ethylene vinyl acetate copolymer, or polypropylene.

20. The composite chemical barrier fabric of claim 19 wherein the thermoplastic olefin coating has a thickness greater than 1 mil.

21. The composite chemical barrier fabric of claim 19 wherein the thermoplastic olefin coating has a thickness of between 1 mils and 10 mils.

22. The composite chemical barrier fabric of claim 13 wherein the thermoplastic olefin is in the form of a free film and subsequently laminated to one or more of the exposed surfaces of the chemical barrier, multiple film composition.

23. The composite chemical barrier fabric of claim 13 wherein the flex crack resistance of the fabric is enhanced by at least 25% through the combination of a multi-layered chemical barrier film and the added layer of thermoplastic olefin resin.

24. The composite chemical barrier fabric of claim 13 wherein the puncture resistance of the fabric is enhanced by at least 25% through the combination of a multi-layered chemical barrier film and the added layer of thermoplastic olefin resin.

25. The composite chemical barrier fabric of claim 13 wherein the fabric is sealable using hot air welding.
